(19) United States
(12) Patent Application Publication
(10) Pub. No.: US 2026/0072720 A1
(43) Pub. Date: Mar. 12, 2026

(54) SEAMLESS POD MIGRATION SYSTEM FOR KUBERNETES ENVIRONMENTS

(71) Applicant: ProphetStor Data Services, Inc., Taichung (TW)

(72) Inventors: Wen-Shyen Chen, Taichung City (TW); Ming-Jye Sheu, Saratoga, CA (US); Li-Wen Chen, Cupertino, CA (US)

(21) Appl. No.: 18/827,882

(22) Filed: Sep. 9, 2024

(51) Int. Cl. G06F 9/455

(52) U.S. Cl. CPC G06F 9/45558; G06F 2009/4557; G06F 2009/45595

(57) ABSTRACT

A seamless pod migration system for Kubernetes environments is disclosed. It includes: a predictive analytics module; a traffic management module which manages traffic routing using a service mesh tool; a volume management module which creates snapshots of a volume of a pod in a source node and clones the volume to a target node; a migration controller which determines migration needs, initiates migration requests to a Kubernetes control plane, checks compatibility between the source node and the target node, and manages data migration; a monitoring module which continuously monitors metrics when data migration is proceeded and reporting performance of the data migration to the traffic predicting server; and a readiness probe module which informs the migration controller when new pods in the target node are available, prompting it to initiate migration requests to the Kubernetes control plane to serve data traffic.

### FIELD OF THE INVENTION

The present invention relates to a system for managing and migrating containerized applications in cloud computing environments. More specifically, it pertains to a seamless pod migration system for Kubernetes environments that utilizes predictive analytics, intelligent traffic management, and pre-copy techniques to meet the needs of modern containerized systems.

### BACKGROUND OF THE INVENTION

VMware is a technology provider that mainly offers virtualization and cloud computing software and services. Virtualization technology allows users to run multiple virtual machines (VMs) on a single physical machine, with each VM capable of running different operating systems and applications. This leads to more efficient resource utilization and reduces hardware costs. Since VMs are independent of the actual hardware of the host machine, they use the same hardware drivers, making VM instances highly portable across different computers. For example, a running VM can be paused, copied to another physical computer serving as the host, and resumed from the exact point where it was paused. It is even possible to move a VM without pausing it. In other words, these VMs can continue running even when they are migrated to different host machines.

On the other hand, the increasing complexity and resource demands of application workloads, especially artificial intelligence (AI) and machine learning (ML), highlight that efficient management and seamless migration of containerized applications are not just important but crucial. As these workloads continue to grow in scale and sophistication, they place significant strain on the underlying infrastructure, underscoring the urgent need for advanced solutions that can effectively maintain performance and availability. While most containerized applications run on VMs, AI and ML workloads require additional resources such as GPUs, in addition to traditional hardware such as CPU and memory. VMware's existing solutions cannot be easily replicated to solve these challenges.

Traditional migration methods in containerized environments, particularly within Kubernetes, often lead to substantial downtime and resource inefficiencies. These methods, which involve stopping the application on the source node, copying data to the target node, and then restarting the application on the target node, not only disrupt service availability but also require significant manual intervention. This leads to operational delays and increased costs. Furthermore, modern AI/ML applications are particular vulnerable to performance disruptions due to their high computational and data throughput requirements. Interruptions or delays in these workloads can significantly impact model training time, inference latency, and overall system efficiency. As such, there is a critical need for a system that can perform seamless pod migrations within Kubernetes environments, ensuring minimal downtime and optimal resource utilization.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

According to an aspect of the present invention, a seamless pod migration system for Kubernetes environments is disclosed. It is installed in a server connected to a traffic predicting server and a Kubernetes control plane within a Kubernetes cluster and comprises: a predictive analytics module that retrieves predictions of Graphics Processing Unit (GPU) utilization, network capacity, and business activity of a service running in at least one pod on a source node in the Kubernetes cluster from the traffic predicting server; a traffic management module that manages traffic routing using a service mesh tool installed in the Kubernetes cluster for data migration between nodes; a volume management module that creates snapshots of at least one volume of the at least one pod in the source node and clones the volume to a target node; a migration controller that determines migration needs, initiates migration requests to the Kubernetes control plane, checks compatibility between the source node and the target node, and manages data migration; a monitoring module that continuously monitors metrics during data migration and reports the performance of the data migration to the traffic predicting server; and a readiness probe module that informs the migration controller when new pods on the target node are available, prompting the controller to initiate migration requests to the Kubernetes control plane to serve data traffic.

According to the present invention, the predictive analytics module further evaluates the migration needs based on the predictions, ensuring optimal GPU and network resources utilization and prevention of performance bottlenecks for data migration.

According to the present invention, the service mesh tool may be Istio or Linkerd.

According to the present invention, the volume management module further pre-copies data of at least one volume of the at least one pod in the source node for data synchronization during data migration, minimizing downtime by transferring bulk data while the at least one pod in the source node is still running.

According to the present invention, the monitoring module further informs the migration controller to initiate migration requests to the control plane based on continuous monitoring and performance analysis, maintaining optimized performance.

According to the present invention, the migration controller further performs compatibility checks between the source and the target node, confirming CPU compatibility, network configuration, and shared storage access.

According to the present invention, the volume management module further creates snapshots of Persistent Volume Claims (PVC) associated with the pods to be migrated, ensuring data consistency and availability.

According to the present invention, the migration controller further updates StatefulSets to use new PVC and create new ReplicaSets, managing replacement old pods with new pods smoothly with created ReplicaSets through a rolling update strategy thereof.

According to the present invention, the traffic management module further uses the service mesh tool to handle traffic management during data migration process, ensuring uninterrupted service and seamless routing of requests to the appropriate pods.

According to the present invention, the monitoring module further provides a performance reporting to the traffic predicting server for ongoing analysis and optimization, creating a feedback loop for continuous improvement.

According to the present invention, the migration controller further cleans up resources on the source node after data migration is completed, ensuring that no unnecessary data or configurations remained in the source node.

According to the present invention, the monitoring module further continuously monitors performance of the pods and resource usage on the target node, ensuring optimal operation of the service.

According to the present invention, the migration controller further updates relevant management logs of the system to reflect the situation of at least one pod in the target node, ensuring accurate tracking and reporting.

According to the present invention, the monitoring module further conducts periodic audits and performs proactive maintenance of the data migration, maintaining the system health and compliance.

According to the present invention, the monitoring module further validates security configurations of the data for migration to ensure data protection and compliance with security policies.

According to the present invention, the migration controller further provides detailed reports and recommendations based on the data migration for improvement to users after the data migration is completed, offering insights into the process of the data migration and potential areas for optimization.

The present invention has advantages below: minimal to zero Downtime: it ensures that AI/ML workloads remain highly available and performant during migrations; optimal resource utilization: it leverages predictive analytics to make informed resource allocation and migration decisions; high availability: it maintains continuous service availability through advanced traffic management and seamless migration techniques; data consistency and integrity: it uses volume cloning and snapshotting to ensure data remains consistent and available during migration; and proactive management: it continuously monitors system metrics and adapts to changing conditions, ensuring efficient and effective resource management.

### BRIEF DESCRIPTION OF THE DRAWINGS

FIG. 1 is a schematic diagram of elements of a seamless pod migration system for Kubernetes environments and application architecture according to the present invention.

FIG. 2A, FIG. 2B and FIG. 2C are parts of a flow chart illustrating how the seamless pod migration system works.

### DETAILED DESCRIPTION OF THE PREFERRED EMBODIMENTS

The present invention will now be described more specifically with reference to the following embodiments.

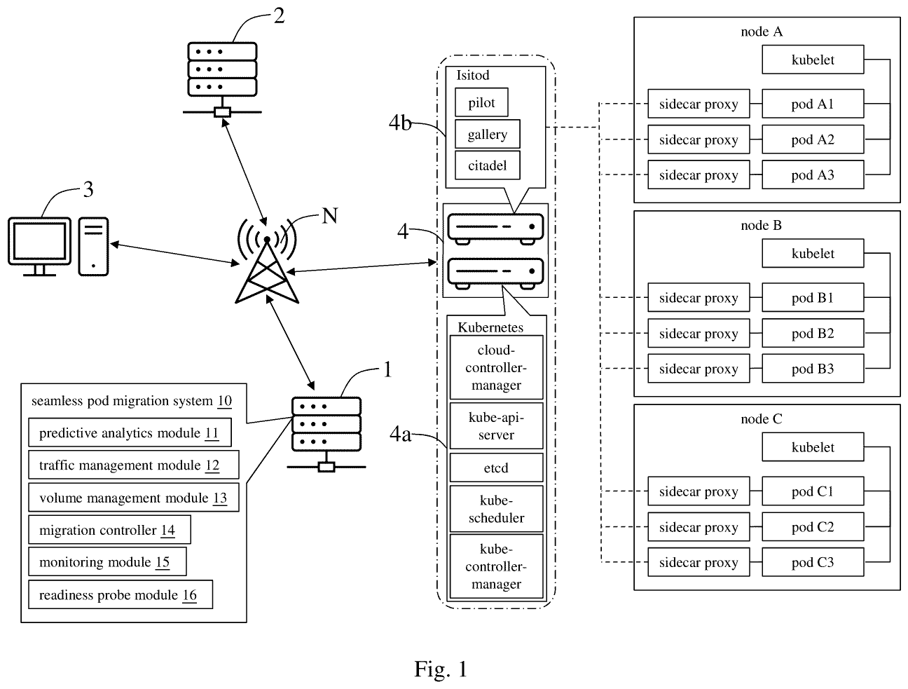

Refer to FIG. 1. A schematic diagram of elements of a seamless pod migration system 10 for Kubernetes environments and application architecture according to the present invention is disclosed. The seamless pod migration system 10 for Kubernetes environments is installed in a server 1. The server 1 is connected a traffic predicting server 2, a Kubernetes cluster 4, and a user end 3, e.g., a workstation for an administrator of a service run in at least one pod in a node of the Kubernetes cluster 4 via a network N. The traffic predicting server 2 is a third-party server providing service of predictions of workloads of the service by analyzing performance parameter comprises, such as Input/output Operations Per Second (IOPS), Graphics Processing Unit (GPU) utilization (percentage of cores used), latency, throughput, and queue, associated with the service from the node. In practice, the traffic predicting server 2 may be the one to run the service provided by Federator. ai GPU Booster, which is operated by the inventor and have related patents, e.g. U.S. Pat. Nos. 11,579,933, 10,606,722, 10,552,329, 10,248,332, 10,157,105, 10,067,704, 10,013,286, 9,906,424, 9,852,009, 9,817,584, 9,619,493, 9,575,664, 9,424,510 and 9,063,799. The Kubernetes cluster 4 includes a number of servers. In the present embodiment, one of the servers is installed with a Kubernetes control plane 4a, which may have components such as cloud-controller-manager, kube-api-server, etcd, kube-scheduler and kube-controller-manager. Another one of the servers is installed with an Istio control plane 4a, which may have components such as pilot, gallery and citadel.

According to Kubernetes cluster architecture, the Kubernetes cluster 4 have a set of worker machines, called nodes. In the embodiment, in order to simplify the description, the Kubernetes cluster 4 have 3 nodes and the nodes are with the same specs. 3 nodes are node A, node B and node C. They all have 3 pods. In other embodiments, the number of the nodes may be more than 3, and the number of the pods may be any positive integer except 3. The nodes are all abstracted to have pods for installing a number of containers. Containers in the same pod all share the same file system, volumes, . . . and other resources. A Kubernetes node is installed with a kebele and a kube-proxy. The former is the primary “node agent” that runs on each node while the latter is in charge of mediating and controlling all network communication between pods. However, according to the present invention, the native kube-proxy is replaced by a number of sidecars which are provided by Istio. Each sidecar deals with network communication only for one pod. Thus, the sidecar has better performance than the kube-proxy.

The seamless pod migration system 10 comprises a predictive analytics module 11, a traffic management module 12, a volume management module 13, a migration controller 14, a monitoring module 15 and a readiness probe module 16.

The predictive analytics module 11 retrieving predictions of GPU utilization, network capacity, and business activity of the service run in at least one pod in a source node in the Kubernetes cluster 4 from the traffic predicting server 2. Type of the service in the present invention is not limited. Preferably, the service may be AI and ML since their workloads continue to grow in scale and sophistication. Planned pod migration is a must for them. GPU utilization is the usage percentage of GPU assigned to the service in at least one pod. Network capacity is the data transfer limit of the service in the network N. It may vary depending on the network traffic and can be tracked. Business activity refers to some events defined by the administrator from the user end 3 and is not a timed or quantitative occurrence. For example, training data for a ML module from the user end 3. However, there is a trend of the business activity to happen and so as to predict the time and amount for the business activity. Historical data of the workloads, namely, GPU utilization, network capacity, and business activity, of the service can be collected by the traffic predicting server 2 and predictions for the workloads in a period of time in the future can be predicted and provided by the traffic predicting server 2. According to the present invention, the service should be run in at least one pod in the source node. The source node is the node now running the service. In this embodiment, the source node is node A with pod A1 and pod A2 installed with the service. The service is running in pod A1 and pod A2. If the size of the service is not large, one pod would be enough. Another term used in the present embodiment is target node. The target node has pods for the data in the pod A1 and pod A2 to be copied to and for the service to run after data has been migrated. In this embodiment, the target node is node C and pod C2 and C3 are used to receive cloned data from pod A1 and A2, respectively.

The traffic management module 12 manages traffic routing between pods in different nodes over the network N. As a component of an external system, the traffic management module 12 is not able to control traffic routing. In order to settle this problem, the traffic management module 12 uses a service mesh tool rather than native routing mechanism in Kubernetes environments. The service mesh tool is installed in the Kubernetes cluster 4 for data migration between nodes It is obvious from the description above that the service mesh tool is Istio. In practice, other similar service mesh tools, such as Linkerd may be applied. One of the advantages of these service mesh tools is providing continuous availability by managing traffic routing during data migration. In addition, the traffic management module 12 can use the service mesh tool to handle traffic management during data migration process, ensuring uninterrupted service and seamless routing of requests to the appropriate pods.

The volume management module 13 creates snapshots of the at least one volume of the at least one pod in the source node, and cloning the at least one volume to the target node. Data in the containers can not be saved for long time and will be disappeared when the container is deleted. Volume is the way Kubernetes stores data. By mounting a Volume to a pod, one can store the data in the pod (container). Snapshots of the pod in the source node can record the entire volume and changes over time in batches. Thus, clone of the whole volume and data stored in the physical storage devices can be done in new pod and may be in new storage devices. The volume management module 13 further creates snapshots of Persistent Volume Claims (PVC) associated with the pods to be migrated, ensuring data consistency and availability. A PVC is a request for storage by a user. Snapshots of the change of the PVC help the seamless pod migration system 10 tracing storage status during data migration from pod to pod. The volume management module 13 can also pre-copies data of at least one volume of the at least one pod in the source node for data synchronization during data migration, minimizing downtime by transferring bulk data while the at least one pod in the source node is still running. The bulk data is somewhere data is not changed for a while and has large percentage of the total data to be migrated. Data synchronization can be done as long as the basic and bulk data is cloned to the target node.

Main job functions of the migration controller 14 are determining migration needs, initiating migration requests to the Kubernetes control plane 4a, checking compatibility between the source node and the target node, and managing data migration. Migration needs of the first job function are objective conditions that allow data migration to be carried on smoothly. For example, data transmission bandwidth above certain conditions, GPU utilization of the workload of the service under a threshold, etc. For this, the predictive analytics module 11 can further evaluate the migration needs based on the predictions for the migration controller 14, to ensure optimal GPU and network resources utilization and prevention of performance bottlenecks (the conditions out of the migration needs) for data migration. Since the seamless pod migration system 10 is not able to directly execute data migration due to the control of the Kubernetes control plane 4a, the migration controller 14 can only initiate migration requests to the Kubernetes control plane 4a (changing some parameters in the Kubernetes control plane). The third job function should be done before any data cloning begins. There are many pods defined in the target node and the one with the same specs as the old pod can be found in the target node. If the new pod's spec is not the same, e.g., having storage 2G less than the old pod, operation of the service definitely will have problem in the future. Therefore, compatibility check is important and should be carried on before migration requests is sent. In addition, the migration controller 14 performing compatibility checks between the source node and the target node is also to confirm CPU compatibility, network configuration, and shared storage access are the same in the two nodes. If the result is not confirmed, a new target node must be found.

In order to achieve the job functions, the migration controller 14 can update StatefulSets to use new PVC and create new ReplicaSets, managing replacement old pods with new pods smoothly with created ReplicaSets through a rolling update strategy of the migration controller 14 itself. A StatefulSet run a group of pods and maintains a sticky identity for each of those pods. It is useful in Kubernetes environments for managing applications that need persistent storage or a stable, unique network identity. The purpose of a ReplicaSets is to maintain a stable set of replica pods running at any given time. By reshaping StatefulSets and ReplicaSets, new PVC can be used, and pod replacement is workable between the source and the target nodes. The migration controller 14 can further clean up resources on the source node after data migration is completed. It ensures that no unnecessary data or configurations remained in the source node. It is like garbage collection technique in memory management. To record detailed information when the seamless pod migration system 10 operates, the migration controller 14 can also update relevant management logs of the system to reflect the situation of at least one pod in the target node. It ensures accurate tracking and reporting for the seamless pod migration system 10. Furthermore, the migration controller 14 can provides detailed reports and recommendations based on the data migration for improvement to users after the data migration is completed. It offers insights into the process of the data migration and potential areas for optimization. This is for the administrator's reference for the next pod migration.

The purpose of the monitoring module 15 is to collect information of the data migration and the results after the data migration is completed. It is continuously monitors metrics when data migration is proceeded and reporting performance of the data migration to the traffic predicting server 2. The metric includes but not limited to amount of used memory, amount of used CPU, GPU utilization, I/O throughput, response time, request per second, and latency. In addition, the monitoring module 14 will inform the migration controller 14 to initiate migration requests to the Kubernetes control plane 4a based on continuous monitoring and performance analysis. It can maintain optimized performance. As information feedback, the monitoring module 15 can provide a performance reporting to the traffic predicting server 2 for ongoing analysis and optimization, creating a feedback loop for continuous improvement. The monitoring module 15 can also continuously monitor performance of the pods and resource usage on the target node, ensuring optimal operation of the service. The monitoring module 15 conducts periodic audits and performs proactive maintenance of the data migration to maintain the seamless pod migration system 10 health and compliance. In addition, the monitoring module can validate security configurations of the data for migration to ensure data protection and compliance with security policies.

The readiness probe module 16 is a controller of the migration controller 14 based on the structure provided by the present invention. When new pods in the target node are available, the readiness probe module 16 will inform the migration controller 14 to initiate migration requests to the Kubernetes control plane 4a to serve data traffic.

Operation of the seamless pod migration system 10 is like a moving company helps a business owner to change office. To make sure the business owner's company can work smoothly when moving, first, someone in the moving company should make sure the new office has the same facilities as the old one. If the spec of the office is not compatible, it needs to find out another office location. This is the job of the migration controller 14 in the present invention. Secondly, someone should note what is the best route and what is the best time that the traffic loading is light for the staffs to move their work items. This is the job of the predictive analytics module 11 and the traffic management module 12. While employees are working in their original office, someone in the moving company starts to arrange new facilities in the new office the same as that in the old office. This is the job of the volume management module 13. Of course, the migration controller 14 also conducts the most important job of data migration. It is like someone in the moving company finishes all remaining issues of changing office.

Below is an example showing how the seamless pod migration system 10 work.

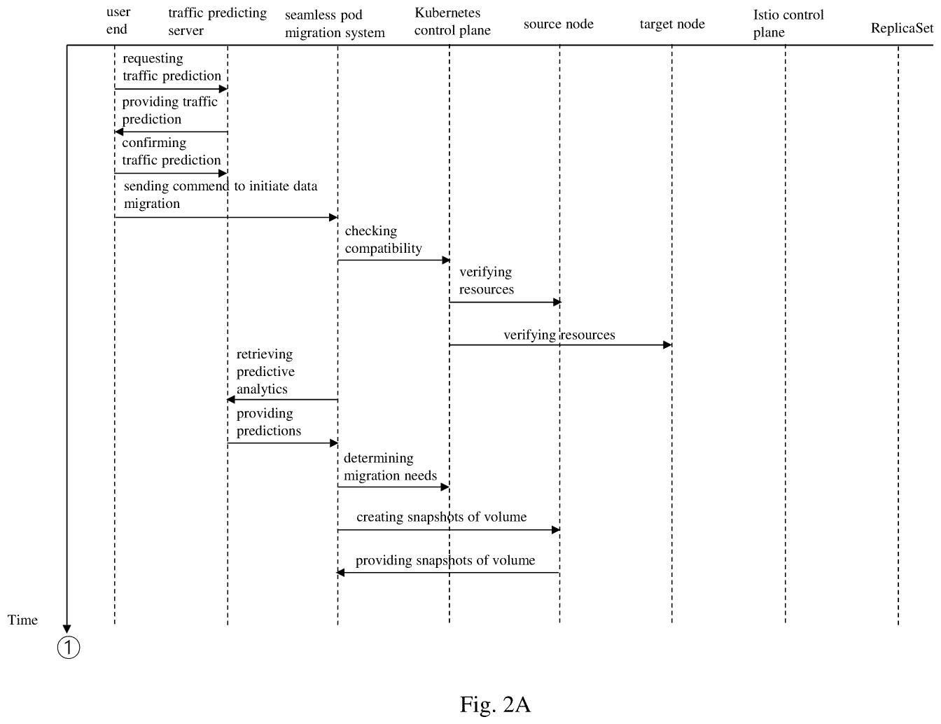

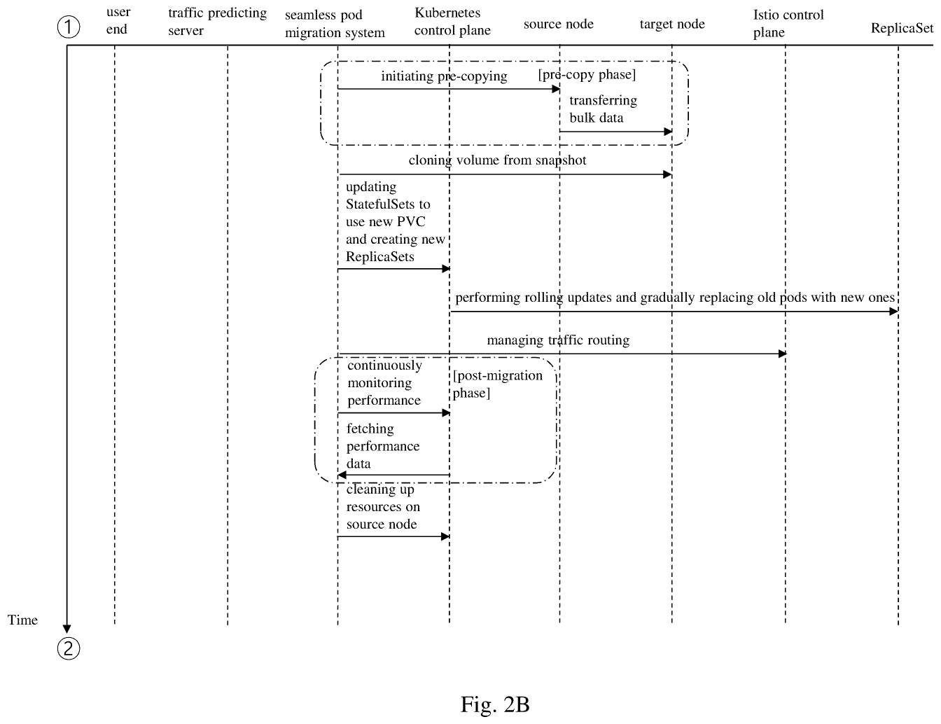

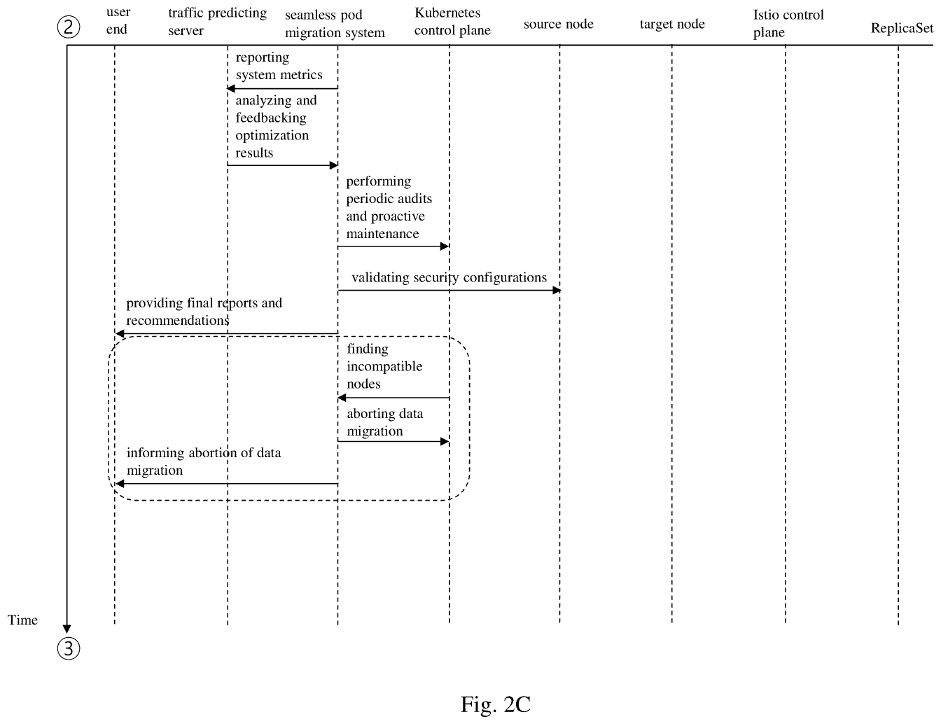

See FIG. 2A, FIG. 2B and FIG. 2C. They are parts of a flow chart illustrating how the seamless pod migration system 10 works. In FIG. 2A, in the beginning, the administrator in the user end 3 requests a traffic prediction for the data migration from the traffic predicting server 2 and the traffic predicting server 2 providing the traffic prediction to the user end 3. After the administrator confirms the traffic prediction is accepted, the user end 3 sends a commend to initiate data migration to the seamless pod migration system 10 in the server 1. The migration controller 14 of the seamless pod migration system 10 then checks compatibility between the pods in the source node and the target node. After verifying the resources are compatible in the two nodes, the predictive analytics module 11 of the seamless pod migration system 10 asks the traffic predicting server 2 to retrieve predictive analysis of the service in the future and the traffic predicting server 2 provides predictions back to the predictive analytics module 11. The migration controller 14 the determines migration needs with the Kubernetes control plane 4a. The volume management module 13 then creates snapshots of the volumes of the pods in the source node. This job is carried on by the source node and the source node provides the snapshots.

In FIG. 2B, the volume management module 13 initiates pre-copying of the bulk data in the source code to transfer them to the target node in a pre-copy phase. In some cases, if the data to be transferred is not large, the operation in the pre-copy phase is not necessary. Next, the volume management module 13 clones volume from snapshots to the target node. Meanwhile, the migration controller 14 updates StatefulSets to use new PVC and creates new ReplicaSets to the Kubernetes control plane 4a. Then, the Kubernetes control plane 4a performs rolling updates and gradually replaces old pods with new ones with the pods scheduled by the new ReplicaSets. The traffic management module 2 managing traffic routing using the Istio control plane 4b. In a post-migration phase which means the data migration is completed and the service can be performed in the new pods in the target node, the monitoring module 15 enters to continuously monitor performance from the Kubernetes control plane 4a and fetches the performance data from the Kubernetes control plane 4a. Since the old pods are no more used, the migration controller 14 asks the Kubernetes control plane 4a to clean up resources on source node.

In FIG. 2C, the monitoring module 15 starts reporting the metrics of the seamless pod migration system 10 to the traffic predicting server 2. The traffic predicting server 2 analyzes and feedbacks optimization results based on the report from the monitoring module 15 to the seamless pod migration system 10. The monitoring module 15 performs periodic audits and proactive maintenance on the Kubernetes control plane 4a. After making a validation on security configurations in the source node, the monitoring module 15 provides final reports and recommendations to the user end 3 to let the administrator to know the data migration is completed and whether there are some points should be taken care for the data migrations in the future. The dashed frame in FIG. 2C shows an optional operation for the seamless pod migration system 10. When the migration controller 14 finds out there are all incompatible nodes in the nodes through the Kubernetes control plane 4a, the migration controller 14 can decides to abort the data migration itself and inform the administrator about this. This can stop wasting time in pending for looking for usable pods.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A seamless pod migration system for Kubernetes environments, installed in a server, connected with a traffic predicting server and a Kubernetes control plane in a Kubernetes cluster, comprising:
a predictive analytics module, retrieving predictions of Graphics Processing Unit (GPU) utilization, network capacity, and business activity of a service run in at least one pod in a source node in the Kubernetes cluster from the traffic predicting server;
a traffic management module, managing traffic routing using a service mesh tool installed in the Kubernetes cluster for data migration between nodes;
a volume management module, creating snapshots of at least one volume of the at least one pod in the source node, and cloning the at least one volume to a target node;
a migration controller, determining migration needs, initiating migration requests to the Kubernetes control plane, checking compatibility between the source node and the target node, and managing data migration;
a monitoring module, continuously monitoring metrics when data migration is proceeded and reporting performance of the data migration to the traffic predicting server; and
a readiness probe module, when new pods in the target node are available, informing the migration controller to initiate migration requests to the Kubernetes control plane to serve data traffic.

2. The system according to claim 1, wherein the predictive analytics module further evaluates the migration needs based on the predictions, ensuring optimal GPU and network resources utilization and prevention of performance bottlenecks for data migration.

3. The system according to claim 1, wherein the service mesh tool is Istio or Linkerd.

4. The system according to claim 1, wherein the volume management module further pre-copies data of at least one volume of the at least one pod in the source node for data synchronization during data migration, minimizing downtime by transferring bulk data while the at least one pod in the source node is still running.

5. The system according to claim 1, wherein the monitoring module further informs the migration controller to initiate migration requests to the control plane based on continuous monitoring and performance analysis, maintaining optimized performance.

6. The system according to claim 1, wherein the migration controller further performs compatibility checks between the source and the target node, confirming CPU compatibility, network configuration, and shared storage access.

7. The system according to claim 1, wherein the volume management module further creates snapshots of Persistent Volume Claims (PVC) associated with the pods to be migrated, ensuring data consistency and availability.

8. The system according to claim 1, wherein the migration controller further updates StatefulSets to use new PVC and create new ReplicaSets, managing replacement old pods with new pods smoothly with created ReplicaSets through a rolling update strategy thereof.

9. The system according to claim 1, wherein the traffic management module further uses the service mesh tool to handle traffic management during data migration process, ensuring uninterrupted service and seamless routing of requests to the appropriate pods.

10. The system according to claim 1, wherein the monitoring module further provides a performance reporting to the traffic predicting server for ongoing analysis and optimization, creating a feedback loop for continuous improvement.

11. The system according to claim 1, wherein the migration controller further cleans up resources on the source node after data migration is completed, ensuring that no unnecessary data or configurations remained in the source node.

12. The system according to claim 1, wherein the monitoring module further continuously monitors performance of the pods and resource usage on the target node, ensuring optimal operation of the service.

13. The system according to claim 1, wherein the migration controller further updates relevant management logs of the system to reflect the situation of at least one pod in the target node, ensuring accurate tracking and reporting.

14. The system according to claim 1, wherein the monitoring module further conducts periodic audits and performs proactive maintenance of the data migration, maintaining the system health and compliance.

15. The system according to claim 1, wherein the monitoring module further validates security configurations of the data for migration to ensure data protection and compliance with security policies.

16. The system according to claim 1, wherein the migration controller further provides detailed reports and recommendations based on the data migration for improvement to users after the data migration is completed, offering insights into the process of the data migration and potential areas for optimization.
